(19) United States
(12) Patent Application Publication
(10) Pub. No.: US 2013/0198619 A1
(43) Pub. Date: Aug. 1, 2013

(54) METHODS AND APPARATUSES FOR HANDLING CORPORATE DOCUMENTS

(71) Applicant: Harjinder Sidhu, Bell Canyon, CA (US)

(72) Inventor: Harjinder Sidhu, Bell Canyon, CA (US)

(21) Appl. No.: 13/364,213

(22) Filed: Feb. 1, 2012

(51) Int. Cl. G06F 17/00

(52) U.S. Cl. 715/255

(57) ABSTRACT

A method of creating a corporate document comprising: retrieving corporate information from a database located on at least one server; receiving inputs for the corporate document via a website; and generating a corporate document from a corporate document template by combining company information and the inputs with the document template.

### FIELD

The present patent document relates to methods and apparatuses for handling corporate documents. In particular, the present patent document relates to a website designed to store and allow dissemination of corporate information and allow the generation of corporate documents.

### BACKGROUND

Thousands of businesses are started every year. The entrepreneurial spirit of business owners drives a large part of the economy in the United States and many other countries around the world. Often, new companies are started on small budgets by individuals that are looking to keep their costs low. To this end, many businesses, especially small startups, may not have the resources to hire corporate attorney's, tax specialists, and accountants to make sure their corporations are filing all the necessary documents and making sure those documents conform to local laws and regulations.

Local laws and regulations of many areas often require corporations to hold meetings between major shareholders, board members and other corporate officials. Under the laws in most areas, these meetings must be held and recorded annually at a minimum. In addition to minutes from periodic meetings, many other types of corporate documents are often required to be filed by law. The situation is complicated by the fact that the local laws and regulations of each local area may differ. Consequently, even owners who are experienced with starting up a company and fulfilling the requirements of local corporate law may not be familiar with the rules and regulations in a new location.

CEOs and owners of businesses would usually prefer to not be saddled with the burden of trying to know every little detail of corporate law and generating all the necessary paperwork. CEOs and owners would rather spend all their efforts marketing and running their business. However, the same CEOs and owners must comply with all the local laws, rules and regulations in order to keep their company in good standing.

In addition, to not knowing when corporate documents may need to be created or may even be required by the local laws, CEOs and other officers of companies may need easy access to all their corporate documents from various locations.

United States Published Patent Application 2003/0069735 (hereinafter the '735 Reference“) to Butler et al. is directed to the formation and organization of a Bermuda corporation. However, the '735 Reference only deals with the formation of companies and does not help CEOs, owners, and officers keep up with the ongoing requirements of a company once the company is formed. Furthermore, the '735 Reference does not help with the creation of the corporate documents.

### SUMMARY

In view of the foregoing, one aspect of the embodiments disclosed in the present patent document is to provide a central repository for corporate documents that may be accessed from various locations. The repository may monitor local requirements and signal when a corporate document is required to be created and/or filed and then assist in the formation of that corporate document. Preferably the methods and apparatuses address, or at least ameliorate, one or more of the problems described above. To this end, a method of creating a corporate document is provided. The method of creating a corporate document comprises: retrieving corporate information from a database located on at least one server; receiving inputs for the corporate document via a website; and generating a corporate document from a corporate document template by combining company information and the inputs with the document template.

In some embodiments, the additional step of comparing the corporate information with local laws to determine when a corporate document needs to be created may be included. In some of these embodiments, the comparing step is designed to ensure a corporation is compliant with at least a portion of the annual corporate requirements of a place of incorporation. In some embodiments, the step of comparing the corporate information with local laws may be repeated at a periodic interval. In some of those embodiments, the periodic interval may be annually.

In some embodiments, the website or server may signal when a corporate document needs to be created. In embodiments that incorporate signaling, the method of signaling may be selected from the group consisting of: email, SMS message, phone call, and icon located on the website.

In some embodiments, the methods and systems described and taught herein are used to create corporate documents for existing corporations. In other embodiments, the methods and systems may be used to create documents for the formation of new corporations.

In different embodiments, various different types of documents may be created. In some embodiments, the document templates used to create the documents may be selected from the group consisting of waiver, meeting minutes, and resolutions.

In different embodiments, the corporate information may include different types of information. In some embodiments, the corporate information includes information about the shareholders of the corporation. In some embodiments, the corporate information includes information about the non-shareholder officers of the corporation. In yet other embodiments, the corporate information may include information about both the shareholders and non-shareholder officers of the corporation.

In various different embodiments, the inventions taught herein may take on various different forms. The embodiment could be represented as a software application, a smart phone application, a java applet, a website or any other digital form. In some embodiments, a website is designed to allow corporate documents to be electronically stored, viewed, and printed.

In another instance of the embodiments of the present patent document, a method of creating a corporate document is disclosed. The method comprises the steps of: retrieving corporate information from a database located on at least one server; providing a template for the corporate document; receiving inputs via a website wherein the inputs are designed to be inserted into the corporate document; and combining the template, corporate information and the inputs to generate the corporate document.

In some embodiments, the additional step of determining that a corporate document needs to be created from the corporate information and signaling that the corporate document needs to be created is included.

In another aspect of the embodiments, a website is disclosed. The website is designed to create corporate documents and comprises: a database designed to store company information; a plurality of corporate document templates; web pages designed to receive inputs; and software, embedded in the website, designed to combine the inputs with company information stored in the database and at least one document template to create a corporate document.

In some embodiments, the website may be used to create corporate documents for existing corporations. In other embodiments, the website may be used in the formation of corporations that do not yet exist. In yet other embodiments, the website may be used to create documents for both existing corporations and future corporations.

In some embodiments, the website software may further compare corporate information with corporate rules associated with a place of incorporation at a periodic interval. In some embodiments, the periodic interval is annually, while in other embodiments the periodic interval may be more or less often.

In some embodiments of the website, the corporate information is compared with the corporate rules associated with a place of incorporation to ensure a corporation is compliant with at least a portion of the annual corporate requirements of the place of incorporation.

### BRIEF DESCRIPTION OF THE DRAWINGS

FIG. 1 illustrates an embodiment of an architecture of a system for managing corporate documents.

FIG. 2 illustrates one embodiment of a website designed to create corporate documents.

FIG. 3 illustrates one embodiment of a login page for a website for creating corporate documents.

FIG. 4 illustrates one embodiment of an initial web page of a website designed to produce corporate documents.

FIG. 5 illustrates an embodiment of a company creation web page for entering company data for use with a website to create corporate documents.

FIG. 6 illustrates a web page to allow entry of information about a company's Officers/Directors/Shareholders (ODS).

FIG. 7 illustrates an initial web page for use in the creation of corporate documents.

FIG. 8 illustrates one embodiment of a web page for inputting a number of document specific inputs.

FIG. 9 illustrates one embodiment of a web page that includes the document specific inputs on the left and the document template combined with the inputs on the right to form a corporate document.

FIG. 10 illustrates an embodiment of a document specific input web page for creating a corporate document related to Meeting Minutes.

FIG. 11 illustrates one embodiment of a web page summary of the document specific inputs along with a draft corporate document that integrates the document specific inputs with modified document specific inputs, corporate information from the database, and template language.

### DETAILED DESCRIPTION OF THE EMBODIMENTS

As used herein, the term “company” or “corporate” is meant to refer to any group of persons united or regarded as united in one body. As used herein, “company” includes but is not limited to corporations, LLC's, partnerships, professional corporations, medical corporations, non-profits, sole proprietorships, any other corporate structure, and their equivalents any where in the world.

The following detailed description includes representative examples utilizing numerous features and teachings, both separately and in combination, and describes numerous embodiments in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

Some portions of the detailed descriptions that follow are presented in terms of algorithms and sequences of operations which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic device, that manipulates and transforms data represented as physical (electronic) quantities within the computer system's registers and memories into other data similarly represented as physical quantities within the electronic device's memory or registers or other such information storage, transmission or display devices.

The embodiments disclosed also relate to an apparatus for performing the operations herein. This apparatus may be specially constructed for the required purposes, or it may comprise a general purpose processor selectively activated or reconfigured by a computer program stored in the electronic device. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, Flash memory, magnetic or optical cards, or any type of media suitable for storing electronic instructions, and each coupled to a computer system bus.

The algorithms presented herein are not inherently related to any particular electronic device or other apparatus. Various general purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the embodiments as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present patent document describes unique systems and methods for storing and maintaining corporate documents. In particular, the present patent document relates to a website where corporate information may be input and then the website may merge that corporate information with various document templates to automate at least a portion of the creation of the corporate documents. In some embodiments, the logic embedded in the website monitors ongoing corporate requirements and may signal through email or other means of communication when a document needs to be created.

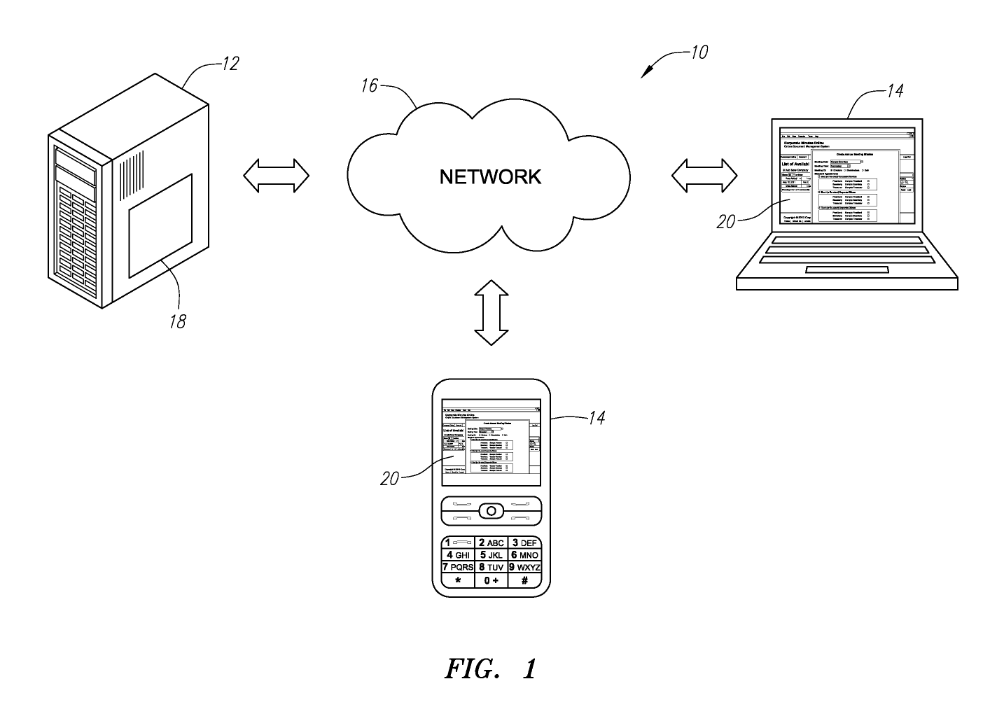

FIG. 1 illustrates an embodiment of an architecture of a system 10 for managing corporate documents. The embodiment shown in FIG. 1, includes a server 12 in communication with a network 16. The server 12 includes a website 18. The network 16 allows viewing devices 14 access to the server 12 and website 18. In a preferred embodiment, network 12 is the Internet, but network 12 may be any network including a LAN or WAN or private network or any combination thereof. In addition, network 16 may be wired or wireless or a combination of both wired and wireless networks.

As illustrated in FIG. 1, viewing devices 14 may include phones and laptops. However, in other embodiments viewing device 14 may be any other type of viewing device including mobile or stationary computing devices, desktop computers, tablets, TV's or any other network enabled device.

The embodiment shown in FIG. 1 includes a single server 12 housing website 18. However, in other embodiments other servers may be used and website 18 may be apportioned across a number of servers. In a preferred embodiment, website 18 includes at least one database and has at least one server dedicated to managing the database(s). However, in other embodiments other configurations may be used. For large implementations, numerous servers to distribute the website and handle the database(s) may be used.

As used herein, the term “website” refers to all aspects of a website including databases, web pages, software, applications or any other software associated with the distribution of the content associated with the website 18 over the network 16.

Although in a preferred embodiment the website serves a web page 20 to a viewing device 14 which in turn displays the web page 20 in a web browser, other forms of interfacing with the website 18 may be used in other embodiments. For example, applications designed to run on a specific device or group of devices may interface with the website 18. A few examples of such applications may be an iPhone® or iPad® application or an application designed to run on an Android® device. Java applets and other forms may also embody the inventions disclosed herein.

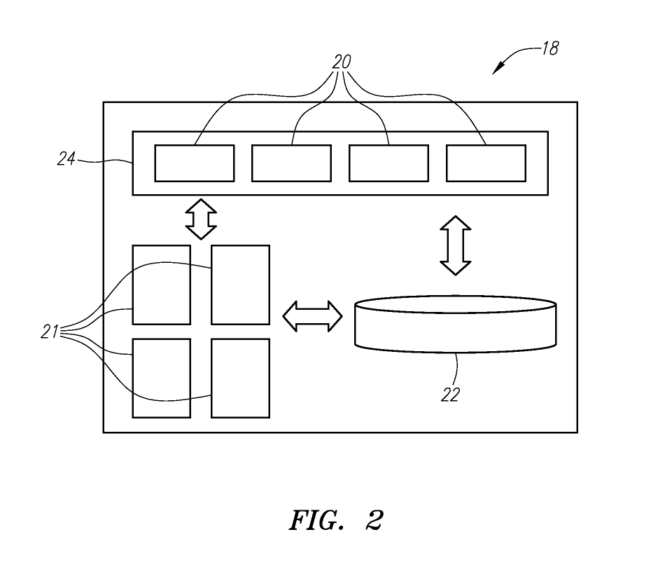

FIG. 2 illustrates one embodiment of a website 18 designed to create corporate documents. Website 18 includes database 22, document templates 21, and presentation layer 24 which includes web pages 20. In other embodiments, website 18 may include more components or less components. In one embodiment, website 18 also includes a logic layer and a security layer. The logic layer handles the data flow between the components and makes decisions while the security layer ensures only the appropriate users may access the website and its data. Those skilled in the art will recognize that websites may have many different architectures, and those various architectures are encompassed by the present patent document.

The presentation layer 24 is designed to present the data to an end user and/or gather data from an end user. In a preferred embodiment, the presentation layer 24 includes a plurality of web pages 20. The presentation layer communicates with the database 22 to either store or retrieve information. The presentation layer may also communicate with the document templates 21 to insert information. In other embodiments, the presentation layer 24 may not communicate directly with the document templates 21 but rather, may communicate with the document templates through the database. For various different website architectures, various different communication paths may be used.

The use of the embodiment shown in FIG. 2 will now be described. An end user enters information about a company into the database 22 via the presentation layer 20. Once the database 22 includes a sufficient amount of information about the company, logic embedded in the website 18 analyzes the data to determine whether any documentation needs to be created. If any documentation needs to be created, the logic signals that a document needs to be created or simply creates the document. The documents are created by merging the appropriate document template 21 with the company information from the database 22. If the document requires additional inputs, those inputs may be received via the presentation layer 24 and combined with the document templates 21 and the corporate information from the database 22.

The embodiments of the document templates 21 may take many forms. In one embodiment the document templates 21 may be embodied in HTML code or other code that is contained either as part of the web page or as part of the website logic. The templates may reside on either the client or the server side. The code may be any language compatible with delivery over the network 16 such as HTML, PHP, Java, Javascript, C, Adobe® Flash, or any other type of code. In other embodiments, the templates 21 may be Microsoft® Word or Adobe PDF files that are opened and edited by the website to combine the necessary information with the template 21 and allow the combination to be presented to the user. In still other embodiments, the templates 21 may be created using other document creation methods known by those skilled in the art.

The logic that forms part of website 18 may include logic related to the laws, requirements, or rules of the local areas of the locations of incorporation of the companies located in the database 22. The laws, rules, and regulations may be used to determine when a document needs to be filed and what the requirements of that document are and/or which document template to use.

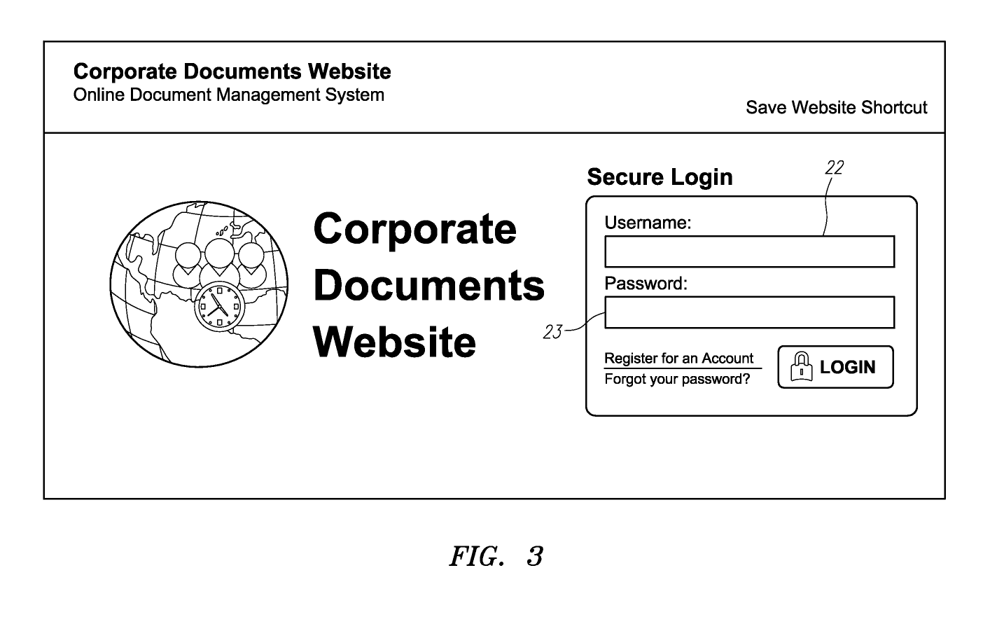

FIG. 3 illustrates one embodiment of a login page for a website 18 for creating corporate documents. The login page includes a username 22 and password 23. In other embodiments, other forms of user identification and authentication may be used. Records in the database 22 may be associated with a particular username and password thus restricting access to the information in the database by user. The login page also provides a level of security to prevent unauthorized users from gaining access to the database or the information contained in the database.

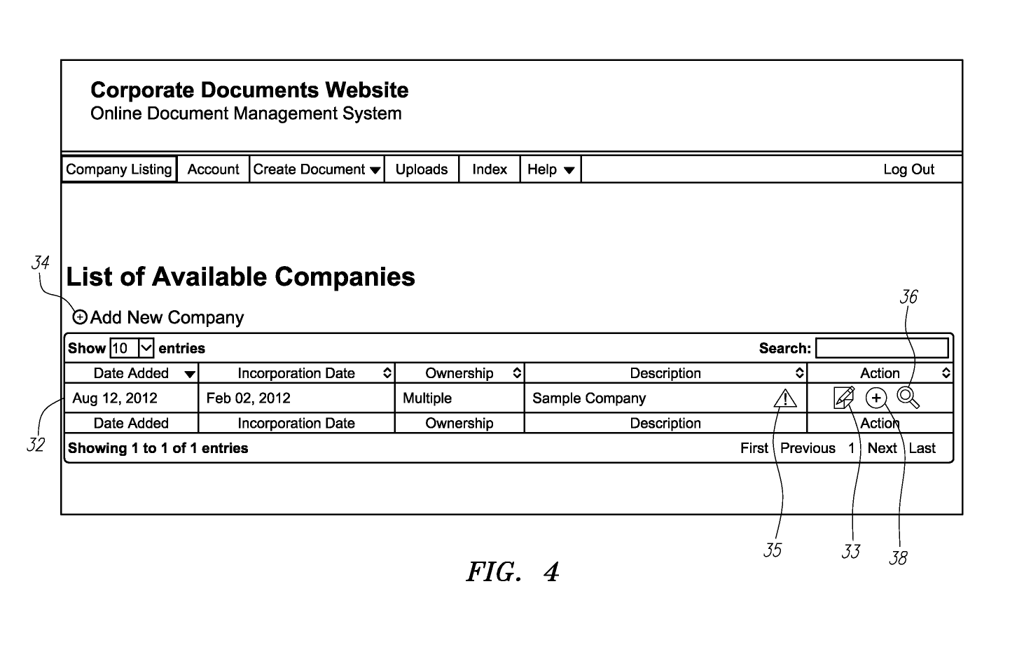

FIG. 4 illustrates one embodiment of an initial web page of a website designed to produce corporate documents. In the embodiment shown in FIG. 4, the user is initially shown a list of companies that are in the database and associated with his/her login. In the embodiment shown in FIG. 4, the login has a single company associated with it, “Sample Company.” From the initial web page, the user may be given a number of capabilities. For example, the user may view documents associated with the company 36, add documents associated with the company 38, view or edit details about the company 33, or add a new company by clicking on the appropriate icon. In other embodiments, other displays, icons, or capabilities may be part of the initial web page.

In addition to the capabilities given to the user on the initial page, the initial page may also signal the user that a task needs to be done 35. In the embodiment shown in FIG. 4, the user is signaled by displaying an icon next to the Sample Company description, however, in other embodiments, other methods of signaling may be used. For example, the user may receive a text message, email, phone call or other form of communication to signal to the user that some action needs to be taken with respect to a particular company associated with the user's login. Such an action may be the creation or filing of a document.

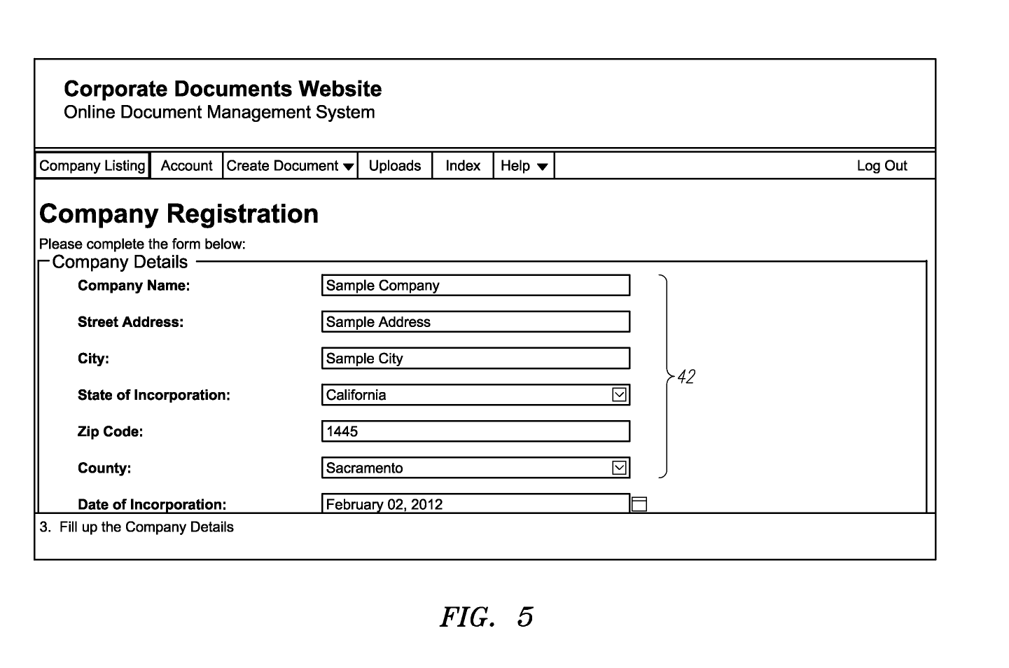

FIG. 5 illustrates an embodiment of a company creation web page for entering company data for use with a website to create corporate documents. When a user first adds a company to his/her profile, the user must input the general information about the company. In the embodiment shown in FIG. 5, a plurality of fields are used to obtain information including: Company Name; Street Address; City; State of Incorporation; Zip Code; County; Date of Incorporation; Type of Organization; Employer's Identification No.; Authorized Shares and Par Value. In other embodiments, more or less fields may be used.

The company creation web page may also include or link to other important documents. For example, if the type of organization is a S-Corporation under U.S. Law, then the company creation web page may link to the appropriate forms or documents, such as tax forms provided by the Internal Revenue Service (IRS).

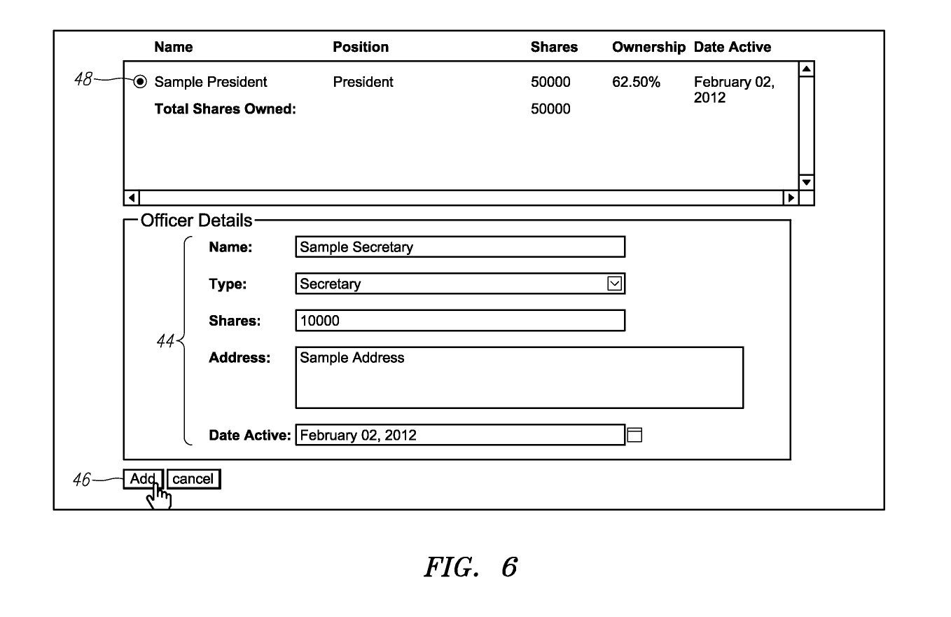

In addition to information about the company, the website may also collect information about the Officers/Directors/Shareholders (ODS). FIG. 6 illustrates a web page to allow entry of information about a company's ODS. As shown in FIG. 6, the website may collect information 44 about the ODS such as: Name; Type; Number of Shares; Address; and Active Date. In other embodiments, other categories of information 44 may be collected.

The web page may also show a summary of the ODS already entered into the system 48. In the example embodiment shown in FIG. 6, a Sample President has been entered. The embodiment of the summary shown in FIG. 6 displays the position, number of shares, ownership percentage, and date active. In other embodiments, the summary view of the ODS already entered may include more or less fields.

In addition to allowing users to enter information about the company's ODS, some embodiments may also allow information about Nominee Officers who are Non-Shareholders, (NNS). Information about NNS may be entered in a similar manner to ODS entries and may be displayed in a similar manner. In some embodiments, the website may also provide the ability to enter information about important company employees or other important people who are not NNS or ODS.

Once the information about the company, ODS, NNS, and other information is entered into the website, the website provides a central location from which anyone with access to the network 16 who has an authorized login, may view, edit, and print the company information. In some embodiments, certain logins may only be given the ability to view and print while other logins may also be able to edit information and perform other tasks. In embodiments where the network 16 is the Internet, users may have access to their corporation data from an unlimited number of locations including their smart phones.

In addition to allowing the user to view/edit/print any of the information about the company, other tasks may be provided. For example, a user may be desirous of converting the company to sole ownership. In one embodiment, the user may simply select the individual currently in the system who is to obtain sole ownership and click on a button labeled sole ownership. The website logic then analyzes the corporate information and figures out what shares will need to transferred in order to create sole ownership in the individual selected. In some embodiments, the website logic may even generate the paperwork required to transfer the shares and vest sole ownership in the selected person.

In other embodiments, other corporate tasks requiring documentation may also be automated and the documents automatically generated. For example, in another embodiment, the website may provide a button to transfer a number of shares to a non-shareholder. Similar to the method for converting a company to sole ownership, a user may simply select the number of shares or person's shares they wish to transfer and then click on a button. The website logic will analyze the request and create the necessary documentation to make the transfer to the non-shareholder. In yet other embodiments, other tasks may also be automated.

In a preferred embodiment, the information entered into the website may be used to both signal when documents are required to be filed by local laws or regulations in order to keep a company in good standing and assist with the creation of those documents. In a preferred embodiment, the document creation system may also be used to create documents that may not necessarily be required but which the user wishes to create.

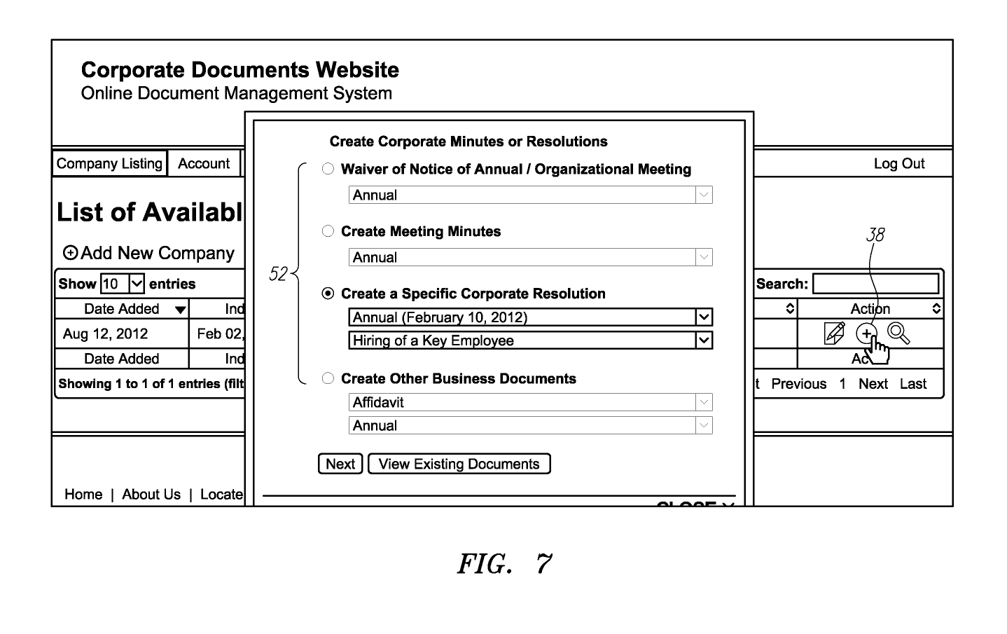

FIG. 7 illustrates an initial web page for use in the creation of corporate documents. In the embodiment shown in FIG. 7, the user initiates the document creation by selecting the add documents icon 38 associated with a particular company. In the embodiment shown in FIG. 7, the user may then select from a plurality of corporate document types including: Waiver/Organizational Meeting; Meeting Minutes; Corporate Resolution; and Other Business Documents. In other embodiments, other corporate document types may be available.

Each category of document type may have a subcategory to further specify the type of corporate document. For example, in the embodiment shown in FIG. 7, the Waiver/Organization Meeting category has subcategories of: Annual; Organizational; Special; and First. The Meeting Minutes category has subcategories of: Annual; Interim; Special; and First. The Other Business Documents category has subcategories of: Affidavit; Certificate; Notice; Articles; Bylaws; and Stockholder's agreement. In some embodiments, the subcategories may have subcategories of their own. For example, in the embodiment shown in FIG. 7, both the Other Business Documents category and Corporate Resolution category have subcategories.

In some embodiments, one category may be dependant on another category. As just one example, the Corporation Resolution category may be tied to the Meeting Minutes category. Creating a Corporate Resolution may be used in instances where it is desirable to create multiple similar resolutions for different recipients, such as opening bank accounts with different banks, hiring more than one person to fill different positions, etc. In this way, the Corporate Resolution will be tied to a specific meeting. For example, a company may want to create a resolution for the hiring of a key employee. That resolution may be tied to the meeting minutes of an annual meeting or other meeting where the hiring was discussed or approved. In other embodiments, other types of dependencies between categories may be used.

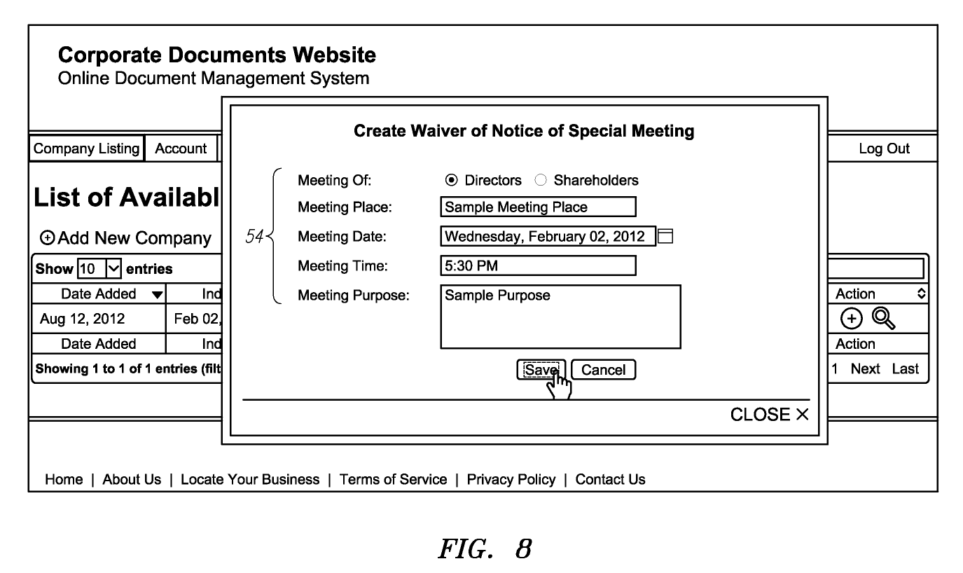

Once the type of corporate document is selected, information or inputs specific to the document may be entered. FIG. 8 illustrates one embodiment of a web page for inputting a number of document specific inputs 54. In the example illustrated in FIG. 8, the document specific inputs 54 include: Meeting of Meeting Place; Meeting Date; Meeting Time; and Meeting Purpose. In other embodiments, more or less document specific inputs 54 may be used. In particular, different corporate documents may need different document specific inputs 54.

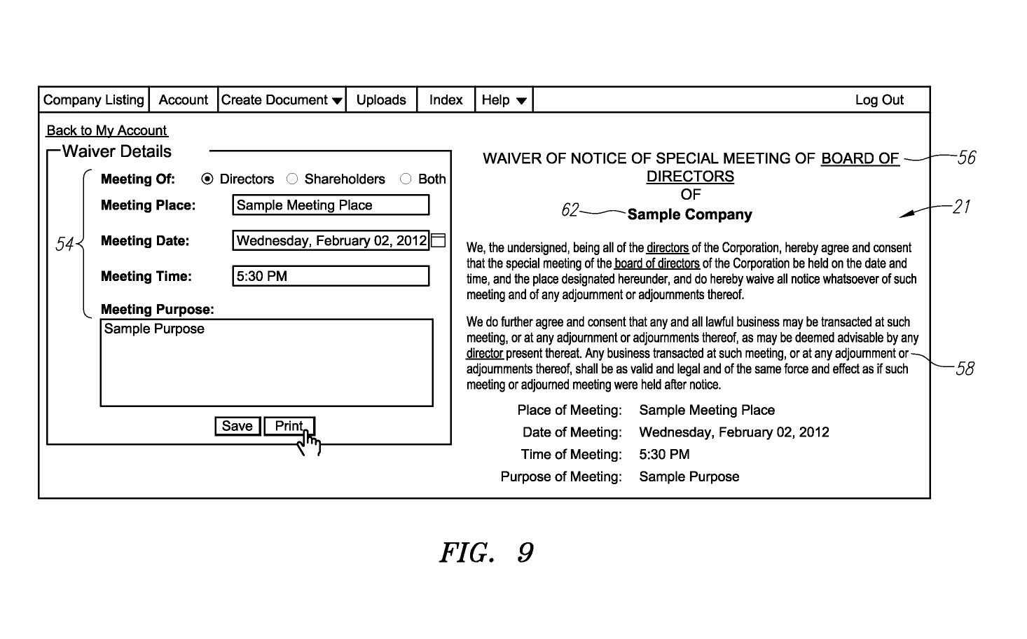

FIG. 9 illustrates one embodiment of a web page that includes the document specific inputs on the left and the document template combined with the inputs on the right to form a corporate document. As may be seen in FIG. 9, the document template 21 may import various types of information to complete the corporate document. For example, document specific inputs 54 may be directly included in the template. Document specific inputs may be modified in format and included in the template 56. As shown in FIG. 9, the document specific input 56 was a radio button that was selected titled Directors. The logic in the website modified that information to create a title to the template consisting of the phrase “Board of Directors.” In other embodiments, the corporate document templates may modify the format of document specific inputs in other ways.

In addition, information about the corporation 62 may be pulled from the database and included in the corporate document by the template 21. As just one example, the Company Name “Sample Company” was pulled from the database and included by the template in the corporate document.

The document template includes additional other template language 58 that describes the purpose of the document and ties the inputs together into a cohesive corporate document. The other template language 58 may be drafted to conform to local laws, regulations or other requirements.

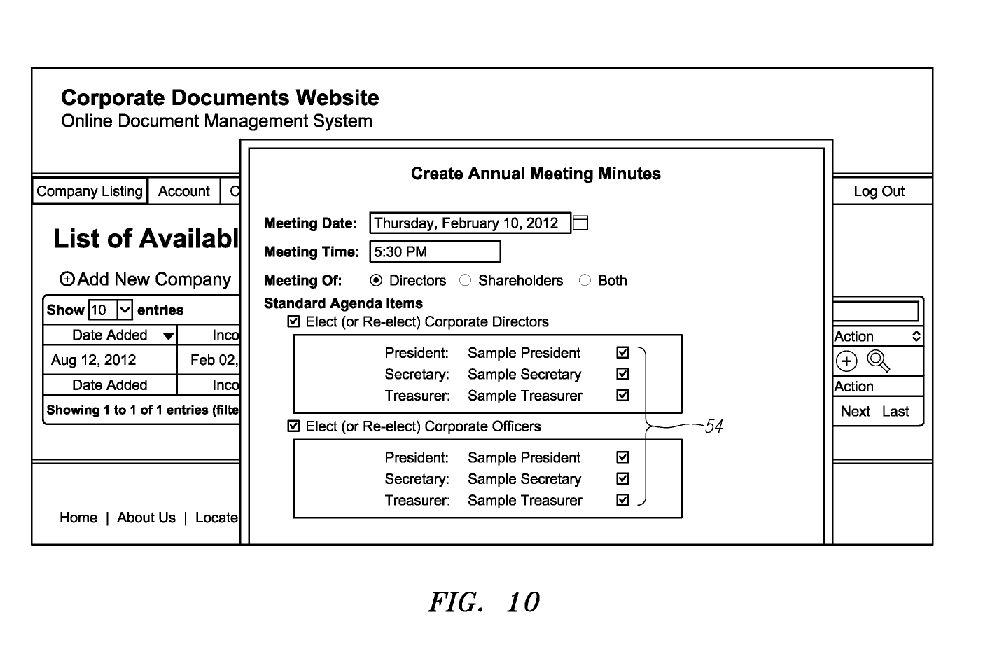

FIG. 10 illustrates an embodiment of a document specific input web page for creating a corporate document related to Meeting Minutes. As may be seen in FIG. 10, document specific inputs may be related to common activities of a company such as electing or re-electing officials.

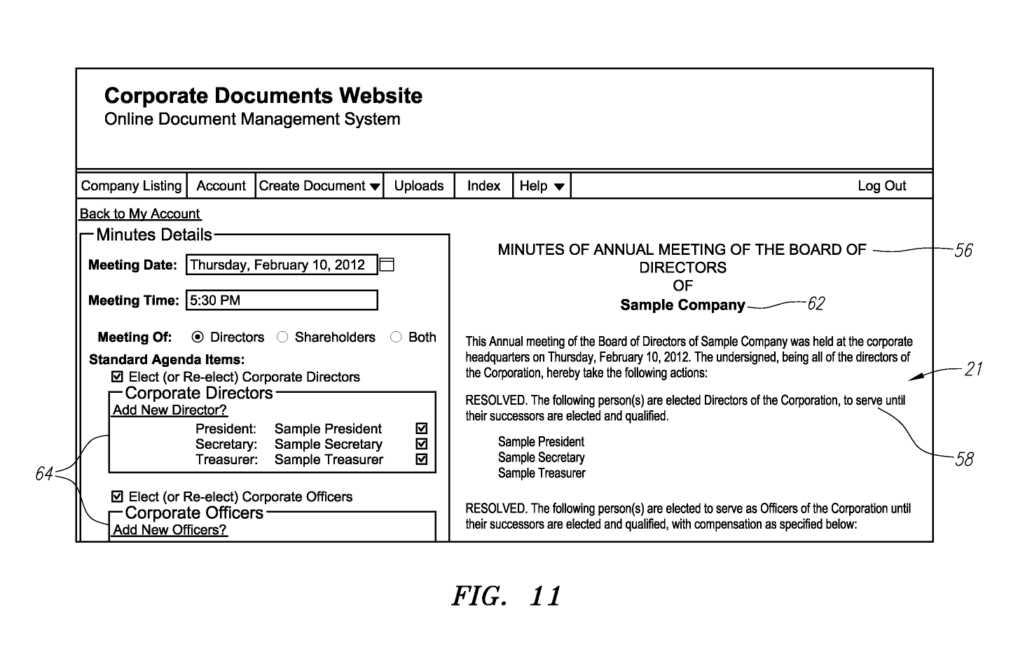

FIG. 11 illustrates one embodiment of a web page summary of the document specific inputs along with a draft corporate document that integrates the document specific inputs 54 with modified document specific inputs 56, corporate information from the database 62, and template language 58. In addition, the summary page may have additional controls 64 to allow the draft corporate document to be modified. In the embodiment shown in FIG. 11, the additional controls 64 allow the user to add a new director or new officer. If one of the additional controls is selected, the website renders a new web page to collect the information about the new director or officer and then the draft corporate document is modified with the additional new information.

The additional controls 64 may also include a number of resolutions a user may select from. For example, in the case of Meeting Minutes, the additional controls may include a list of items covered during the meeting such as: Authorization to Enter into Contract; Authorizing an Annual Dividend, Retaining a Professional such as an Attorney or Accountant, Opening a Bank Account, Obtaining a Corporate Credit Card, Purchasing Equipment, Lease Property, File for Bankruptcy, or Hiring a Key Employee. In other embodiments other company actions may be included.

If the user selects one of the resolutions, the template 21 will automatically incorporate into the Meeting Minutes that the resolution was approved. The website may then be used to automatically generate the resolution.

In the embodiment shown in FIG. 11, the draft corporate document is shown side by side with the document specific inputs and additional controls 64. In a preferred embodiment, the user may change the document specific inputs and/or select additional controls 64 or add or subtract resolutions and then click update to update the draft document. The document template 21 incorporates all the changes automatically and the website displays a new draft with the changes. This process may be iterative until the corporate document is satisfactory.

In one embodiment, when a resolution is selected to insert into a corporate document such as the Meeting Minutes, the website automatically generates a link for the creation of the actual corporate document resolution. The resolution template may be different from the Meeting Minutes template but completed with document specific inputs in a similar manner.

All the documents that are created may be accessible from the main screen of the particular login. In a preferred embodiment, the main screen contains a number of tabs to organize the type of documents. For example, the main screen may have tabs for: Minutes; Resolutions; Waivers; Other Documents; Start Up and Uploaded Files. In other embodiments, other tabs to organize the files may be used.

The website may be used for storing, tracking, printing, and editing many corporate documents. A few examples of the types of documents that may be automatically created include: Bylaws, Articles of Incorporation, Meeting Minutes, Resolutions, Affidavits, Certificates, Notice and Waivers to name a few.

In some embodiments, the website may also be able to electronically file certain documents with the appropriate authorities. For example, the location of incorporation may require an annual statement from the corporation or minutes from an annual meeting. Once the appropriate corporate document is created, the website may be able to electronically file it with the appropriate authority through the network 16.

In addition, in a preferred embodiment, the corporate documents are freely editable by a login with the appropriate authority. Once the document templates have automatically integrated the document specific inputs and other information into a cohesive corporate document, a user with the appropriate login authority may freely edit the document to add or subtract other information.

In addition to creating documents, the website may also be used as a repository for all the corporate documents. Safely storing all the corporate documents online, allows them to be easily accessed, viewed, and printed from anywhere with a network connection. While copies of documents created through the website are automatically stored and available, documents created outside the website may be uploaded.

The website may be used to upload any type of document including Microsoft Office® documents, pdfs, images such as jpeg's, tiff's and giff's and others, video files, text documents, or any other document. When uploading the documents, the user may associate the documents with a particular company. In some embodiments, the website may organize the documents in a tabbed interface to allow the user to quickly sort between documents related to, Minutes, Resolutions, Waivers, Startup, Other Documents, or Uploaded files. In addition, the website may have an index which organized and shows all the created and uploaded documents. In any of these views the user may be able to sort by Document Date, Date Created, Document Type, Status or any other document property. Once the document has been uploaded, the user may now access the document from anywhere the user has access to the website. The document is also protected from loss and corruption.

What is claimed is:

1. A method of creating a corporate document comprising:
retrieving corporate information from a database located on at least one server;
receiving inputs for the corporate document via a website; and
generating a corporate document from a corporate document template by combining company information and the inputs with the document template.

2. The method of claim 1, further including the step of comparing the corporate information with local laws to determine when a corporate document needs to be created.

3. The method of claim 1, further including the step of signaling when a corporate document needs to be created.

4. The method of claim 3, wherein the method of signaling is selected from the group consisting of: email, SMS message, phone call, and icon located on the website.

5. The method of claim 1, wherein the corporate document created for an existing corporation.

6. The method of claim 2, wherein the comparing step is designed to be repeated at a periodic interval.

7. The method of claim 6, wherein the periodic interval is annually.

8. The method of claim 1, wherein the comparing step is designed to ensure a corporation is compliant with at least a portion of the annual corporate requirements of a place of incorporation.

9. The method of claim 1, wherein the document template is selected from the group consisting of waiver, meeting minutes, and resolutions.

10. The method of claim 1, wherein the corporate information includes information about the shareholders of the corporation.

11. The method of claim 1, wherein the corporate information includes information about the non-shareholder officers of the corporation.

12. The method of claim 1, wherein the website is designed to allow corporate documents to be electronically stored, viewed, and printed.

13. A method of creating a corporate document comprising:
retrieving corporate information from a database located on at least one server;
providing a template for the corporate document;
receiving inputs via a website wherein the inputs are designed to be inserted into the corporate document; and
combining the template, corporate information and the inputs to generate the corporate document.

14. The method of claim 13, further including the step of determining that a corporate document needs to be created from the corporate information and signaling that the corporate document needs to be created.

15. The method of claim 14, wherein the signaling is accomplished via email, SMS message, phone call, or an icon located on the website.

16. The method of claim 13, wherein the corporate document is selected from the group consisting of waiver, meeting minutes, and resolutions.

17. The method of claim 13, wherein the website is designed to allow the corporate documents to be stored, viewed, and printed.

18. The method of claim 14, wherein the determining step is designed to be repeated at a periodic interval.

19. The method of claim 18, wherein the periodic interval is annually.

20. The method of claim 14, wherein the determining step ensures a corporation is compliant with at least a portion of the annual corporate requirements of a place of incorporation.

21. A website designed to create corporate documents comprising:
a database designed to store company information;
a plurality of corporate document templates;
web pages designed to receive inputs; and
software, embedded in the website, designed to combine the inputs with company information stored in the database and at least one document template to create a corporate document.

22. The website of claim 21, wherein the corporate document is being created for an existing corporation.

23. The website of claim 21, wherein the software further compares corporate information with corporate rules associated with a place of incorporation at a periodic interval.

24. The website of claim 23, wherein the periodic interval is annually.

25. The website of claim 20, wherein the corporate information is compared with the corporate rules associated with a place of incorporation to ensure a corporation is compliant with at least a portion of the annual corporate requirements of the place of incorporation.
